(19) United States
(12) Patent Application Publication
(10) Pub. No.: US 2015/0039338 A1
(43) Pub. Date: Feb. 5, 2015

(54) DIGITAL AND COMPUTERIZED INFORMATION SYSTEM TO ACCESS CONTACT AND MEDICAL HISTORY DATA OF INDIVIDUALS IN AN EMERGENCY SITUATION

(71) Applicant: Jorge Pablo TREGNAGHI, Cordoba (AR)

(72) Inventor: Jorge Pablo TREGNAGHI, Cordoba (AR)

(21) Appl. No.: 13/956,642

(22) Filed: Aug. 1, 2013

(51) Int. Cl. G06F 19/00

(52) U.S. Cl. CPC G06F 19/322
USPC 705/3

(57) ABSTRACT

A digital information system that any individual may join through a terminal with Internet access, to provide a participating user with a special service in the event of an accident and a need for the user to receive emergency assistance. The system provides access to the user's most important emergency data by an intervening professional assistant, who may inform the assisted user's contacts regarding the accident. The system includes a combination of resources that are functionally and mutually linked, including a QR code, a user, a central administration, and an emergency assistant.

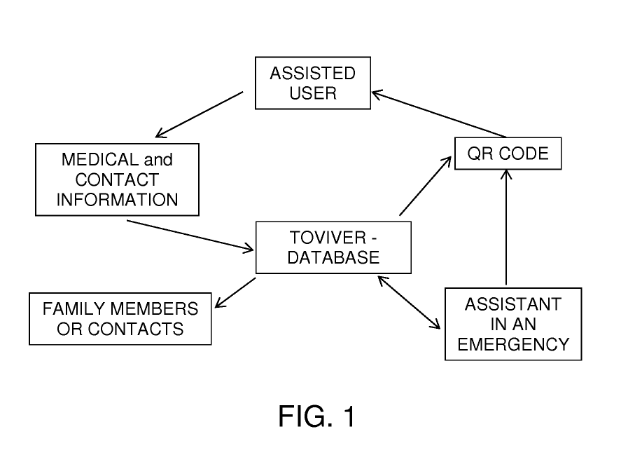

### SCOPE OF INVENTION

This invention, for which an invention patent is being requested, has as its principal objective a digital and computerized information system to access contact a medical history data of individuals in an emergency situation, especially created to develop a system to prepare, handle, and process said digital information from which, by using any device capable of reading a QR code (mobile phone, smart card, chip, or something similar), makes it possible to access said information in a safe manner, 24 hours a day, 365 days a year.

This is a digital information system which any individual may join through a terminal with Internet access, in order to register as a user in a Central Administration which centralizes and systematizes the preparation, handling, and processing of the individual's contact and medical history information, thus allowing each one of the actors involved to access said information in case of an emergency by reading the corresponding QR Code module.

More specifically, this invention refers to a Digital Emergency System that is intended to provide the user participant with a special service in the event of an accident on the roads and if the user needs assistance. This service, allows emergency assistants to access the users most important emergency information in order to be then used by the intervening professional assistants, who will also be able to inform the contacts of the user being assisted regarding the accident.

Although there are different systems that systematize medical histories, the system in this invention stands out as extremely flexible, given that every institution, professional, insurance entity, or government may access the individual's actual information, and the individual can change (in function of the implementation) the information model structure, the way it is presented, and the information itself.

Starting from this operational principal, it is possible to build medical history software that can be commercialized as a license, including training and assistance for each individual client, as needed. The clients who would be interested in accessing this innovative system are: ministries, governments, health insurance providers, organizations that provide emergency services, all types of public and private institutions, clinics, and other organizations associated with the healthcare system, life insurance companies, medical insurance companies, and other similar entities, etc.

This may also be described as an omnipresent system (accessible from the actual location and at the time it is needed). The use of different networks: Internet, GPRS, and EDGE will allow for minimum coverage of 100% in cities, 80% in semirural areas, and 50% in rural areas.

It is also notable for its confidentiality feature (based on encryption and digital signature mechanisms). U.S. Drug and Food Administration's (FDA) strict regulations are applied, in this specific case the Code of Federal Regulations (CFR) Title 21, Part 11.

In fact, this is unique because it displays information in the language of the region where the incident takes place, in function of measurements and time zones.

The invention includes the possibility of installing a system that can coexist with other tools, such as the Clinical Orientation system or else the digital vaccine system, as well as the contents of the Cedepap.tv portal, including the capability to use texts, audio, video and diagnostic images, 3D MRI, etc.

It is clear that this is a system capable of being implemented either individually or communally, or as a “spinal column” of an integrated health system (public or private).

Through the invented system it will be possible for medical facilities, health services and patients in general have access a safe, portable, and flexible system of emergency digital medical histories, available instantly and wherever it is needed.

It will also be possible to add databases (nonexistent today) to facilitate scientific, epidemiological, and health-related analysis, as well as management and educational applications, and therefore it will be possible to improve medical practice by providing a tool that drastically increases the quality of decision making, by relying on better information at the time when it is needed; this will have an impact on morbidity and mortality and thereby on public health.

The system according to the present invention enables:

better health services planning;
facilitating the portability of medical data for telemedicine and cooperative medical activities;
providing a natural framework to establish a pharmacovigilance system;
taking advantage of the capillarity of mobile phone networks, broadband, telephony, etc., to make digital emergency medical histories omnipresent; and
implementing the portability of information by improving the patient's control over his or her own medical information.

Taking into account the statements made in prior paragraphs, it is very important to distinguish the enormous difference between traditional, written medical histories and the new system referred to in this invention.

The innovative technological leap is immense; the new technology is not tied to canned formats or forms; it will have the capacity to manage information as each user requires it (medical, clinic, hospital, patient) and may load all this information to the clinical profile. The patient will hold on to and personally carry in the individual QR his or her medical emergency record.

According to this invention, an innovative digital information system is created that includes a combination of resources, functionally and mutually linked, which can be defined as follows:

QR Code=A specific QR Code is created for each user who participates in the invented system, which constitutes a link of set parameters with the identifier (ID) specifically based on user information, and through which it is possible to enter to Central Administration using the mobile phone with Internet access version.
US User=Integrates the system and carries the QR Code properly processed and obtained by accessing Central Administration. The invention includes in this category users who could be included through either free or paid memberships, who will have access to more benefits.
Central Administration=It is constituted in the “server” that carries the database and stores the users' medical and contact information, and includes:
Emergency system service administrator: who will be enabled to set the parameters, create new types of emergency information, etc.
Users Administrator, emergency service professionals, enabled to create accounts with institutions that are authorized to provide emergency services.
   Emergency assistants=Those who have access to the server through the user's QR code when providing assistance during an emergency, this includes:
Non-professional assistant: An individual who has access to the Server only to take and transmit contact and basic medical information. This is a person who is present at the accident scene and has a mobile device and scanning software capable of reading a QR code, and thereby access to a user's public information in the invented Digital Emergency Medical History System.
Professional assistant: This is an individual who is part of the system that has the capability to access important medical diagnostic information in order to guide the emergency response treatment.

### PRIOR ART

Until de mid '80s the use of information technology was concentrated almost exclusively in medium-sized and large companies; specifically, it was used in administrative and financial processes; it was also used by banks, universities and government agencies.

Despite the growing scientific and technological advances in medicine and medical science, key aspects, such as medical histories, were relegated to the back burner.

Medical histories are the spinal column of medical practice, nonetheless the general use of information technology tools in this area have been delayed. Including today, there are few medical facilities that structure their medical histories through a digital process.

This gap between information technology and communication (ICT) has not changed and it arises from a set of circumstances, among which the following stand out:
The medical records policy is immensely diverse and complex, and differs significantly among facilities.
The medical records policy in one single facility changes and develops over time, given that medical science in itself is a research science that is in constant development.
The lack of planning in relation to healthcare management.
The historical lack of healthcare program performance evaluations in many countries, except in hindsight (when errors can't be corrected anymore).
Generational gap in the professional field.
Insufficient academic training in medical careers in the use and possibilities offered by information technology and telecommunications.
Difficulties in finding canned software that is compatible with different realities, and the difficulties of developing software that will satisfy requirements over a long period of time.

It is fair to say there is no other known systems, communication systems or information technology resources related with this specialty that are capable of offering medical history information that have the following characteristics:
Omnipresent: so that the information is available wherever and whenever it is needed.
Universality: so that it answers to a standard that allows for comparison and communication, as well as to extrapolate information with other computerized information systems.
Flexibility: so that it adjusts to the different forms of recording information that may arise.
Low resistance to change: looking to make it very functional for those who provide service and contribute great advantages to the users.
Greater adaptability: to provide an information support system for decision-making, according to the local situation and in a timely and efficient manner.

There are some disclosures that originate in foreign countries that show some progress in regard to computerized medical histories, each one with its corresponding characteristic, of which we highlight the following:

To this effect, US published patent application US 2012/0179908 titled “SECURE PORTABLE MEDICAL INFORMATION SYSTEM AND METHODS RELATED THERETO” is mentioned, and its summary describes the following:

Using a secure portable reference to medical information, stored on a portable storage medium, various embodiments allow a patient to give to their doctor an easy-to-use access tool and access code to desired medical information stored on a computer network. The secure portable reference provides greater transportability of medical records to a patient or medical data repository including a doctor's office, clinic, or hospital, while maintaining data security to satisfy medical data privacy regulations and expectations. Some described embodiments use encrypted information inside the secure portable reference to hide, for example, who is allowed access to the stored medical information, and the network location of the stored information. Some embodiments use a secret PIN to authenticate the user attempting access to the referenced medical information. The secure portable reference contains information on network resources used to enable download access to medical information, including medical records and medical images.

Nevertheless, this antecedent does not disclose how to access these medical histories in an emergency situation.

US published patent application US 2012/0280049 is also cited. In this case, the invention provides patient emergency or critical healthcare information, such as allergies, medications, diagnosis, doctor and hospital information to emergency healthcare providers, yet this information maintains patient confidentiality through the use of a QR code. The information is unseen or unavailable to the naked eye and is only visible with a specific type of reader or application. The healthcare information, determined by the owner, resides behind or within an image or Quick Reference (QR) code and this image or QR code has to be scanned with a QR reader or application in order for it to be seen. The QR Personal Health Record (PHR) identification card, laminated or not, is about the size of the business card that easily fits in a pocket. Other ways to use this PHR ID card is through a key fob, bracelet, charm, cell phone sleeve, and pendants.

Although it is clear that a QR code is also used, the code is not part of a system that is able to resolve an emergency situation on the road. Only those individuals who are registered and duly authorized have access to read the code. Therefore, this is another disclosure that excludes the possibility of individuals who are not registered to receive assistance, a situation that would render the system obsolete.

US published patent application US 2008/0228529 “CONTEXT ADAPTIVE PATIENT MEDICAL DATA ACCESS AND VIEWING SYSTEM” is also cited, which discloses a system for providing a user with an adaptive view of patient-specific medical data required for an executable clinical information application. A context processor identifies associated clinical information data to an application that may be employed by a user. The context data includes a patient identifier and a user identifier. A configuration processor enables a user to indicate predetermined medical information to be accessible and displayed via a reference display image window. At least one Administrator stores information provided by the configuration processor, associating, for multiple different users, a user identifier with predetermined medical information that is displayed in a reference display image window for a particular user. A user interface processor employs at least one repository for initiating generation of data representing a composite display image including and concurrently presenting a first image provided by the clinical information application and a reference display image window as an overlay of the first image. The reference display image window shows user interface elements enabling user initiation of display of predetermined types of medical information of a particular patient selected in response to a patient identifier and user identifier provided by the context processor.

As can be seen, it is a close system that does not use QR technology, which today offers an enormous advantage of accessibility, given it is available in all intelligent mobile phones. US published patent application Patent US 2012/0253851 is also cited, which refers to a System And Method For Controlling Displaying Medical Record Information On A Secondary Display.

A computer implemented method is disclosed to display patient medical data during an interaction between a patient and a physician. The method includes receiving an identification of a patient at an electronic medical record server and transmitting patient medical data from an electronic medical record associated with the identified patient to the healthcare provider computing device. The method further includes identifying the location of the provider computing device, transmitting an activation key to a secondary display device for display on the secondary display device, and receiving confirmation from the healthcare provider computing device that the activation key was entered into the healthcare provider's computing device. Following activation, the method includes displaying information from the electronic medical record on the secondary display based on a command received from the healthcare provider's computing device.

This antecedent also does not explain how to apply the system in an emergency situation through a QR identification code that enables access to the user's data.

U.S. Pat. No. 7,578,432 titled “METHOD FOR TRANSMITTING MEDICAL INFORMATION” is also cited.

It discloses a method for transmitting personal health information from a databank to a health facility. An individual's health information is stored in a database, and the information is sent to authorized users as needed. The information is stored in the database by coding an individual's private file with a unique identifying number. The individual is provided with an electronically readable identifier (ERI) that corresponds to the unique identifying number. The ERI can be scanned by professional assistants with the appropriate scanner. The scanner is authenticated by the database, and the information corresponding to that individual is sent back to the scanner for use by the emergency professional assistants. The health information can also be sent to a hospital. The entire process requires authentication of the professional assistants and validation of the ERI for security purposes.

It can be seen that this antecedent also refers to access to medical history information destined for internal use for hospital users and other healthcare professionals, but it does not include in the system the possibility to access by individuals who may occasionally provide first aid. Probably for this same reason, the last few documents have also not addressed the question of data safety.

Published US patent application US 2007/0088559 is also cited as an antecedent, which refers to a method for computerizing and standardizing medical information which can provide web screens through terminals to enable doctors, nurses, pharmacists, or the like to immediately online input and read a variety of information created upon treating and caring for patients in a hospital, and can standardize medical information input or represented through the web screens, such as various medical information, nursing information, medicine information and the like.

Published US patent application US 2012/0117232 is also mentioned, which refers to a method and system for collecting and recognizing information from a monitoring device is provided. On a mobile computer device a user can capture an image of a monitoring device. The image captures at least two aspects: (1) monitored data tracked or acquired by the monitoring device, and (2) a portion of the monitoring device sufficient to recognize the monitoring device. Recognition functions are provided for: (1) recognizing and converting the monitored data visible in the captured image into quantifiable data, and (2) for recognizing the monitoring device. A note taking function can be provided to allow a user to create notes. The notes can be enriched with the quantifiable data and/or the recognized monitoring device (or vice versa). A suggestion function can be provided for suggesting services where the quantifiable data, the recognized monitoring device, and/or the notes can be bound.

This disclosure also does not show how to install a system that is capable of application in an eventual medical emergency, using a QR code to access the medical history of the injured individual.

### DETAILED DESCRIPTION OF THE PREFERRED EMBODIMENT

As previously stated the digital and computerized information system to access contact and medical history data of individuals in an emergency situation, referred to in this invention, includes:
a) A QR Code specific to each user who participates, which functions as a set parameters link with the ID specifically based on user information, and through which it is possible to enter to Central Administration by using the version for mobile phone with Internet access.
b) A User (US) carrier of a QR code defined in the prior paragraph.
c) A Central Administration (CA) which defines the server that carries the database and stores users' medical and contact information. This central administration includes c-1) an Emergency Service Administrator, essentially established to control the system, create new types of emergency data, etc.; and c-2) a Users Administrator, established to create accounts with institutions that are authorized to provide emergency services.
   Emergency Assistants (EA) who access the server by reading a QR code of the user who is being assisted during an emergency, includes: d-1) Non-professional assistant: who accesses the users (US) QR code in an emergency in order to take and transmit contact and basic medical data; d-2) Professional assistant: who access the QR code of the user who is being assisted during an emergency, and has the capability of accessing important diagnostic medical data in order to guide the emergency assistance.

### BRIEF DESCRIPTION OF THE DRAWING FIGURE

The drawing FIGURE is a flowchart according to which the system according to the present invention can function.

As previously described, first of all it must be emphasized that it is a system that uses as unique identifying QR code as a link to access the system and information of this code; this excludes the need for new identifications or encryption numbers, reducing the step process.

The link is encrypted according to international security standards, similar to those of banking information. The links are unique and personal for each subject or client.

Under the conditions stated, resorting to the digital and computerized information system of this innovation in order to participate as a user (US), it will be necessary to access Central Administration (CA) through an application that connects through the Internet, which could be a computer, an appropriate cell phone, etc. This way a user account is created that generates a unique identifier based on the data of said user, which will serve to create a unique link to his or her information. When a user account is created and during said process a QR code is created that encrypts a public Web link to the user's information; said link is based on and contains the user's unique identifier, which was generated based on data at the time the account was created.

The user defines and integrates the contact and basic medical data into the system, which are useful to take into account in the event of an emergency. Said data may include the following:
Personal Information: First and last name, DNI [National Identification Document], Address, Blood Type.
Medications: the user defines the medication that he or she takes, so that whoever is providing assistance can be aware of the contraindications. The system enables to define dosage, route of administration, date of administration, and reason for taking the medication.
Allergies: The user defines pre-existing conditions and comments related to these conditions.
Medical conditions: The user defines pre-existing conditions and comments related to these conditions.
Miscellaneous: A section that allows the user to define miscellaneous generic observations; for example, medical professional contact information (the user's attending physician) or contact information of family or friends who may be contacted in case of an emergency.

Preferably, the data stored in the system is described in modules: This information in modules, provided for in the invented system, contemplates the possibility that the user can decide to subdivide the module in at least two types of modules, namely: those designated for emergency situations only, where only necessary information is shown to establish contact with family members, healthcare providers (attending physician), and other very basic personal information, such as blood type, chronic illnesses, medications, and allergies. This information can be accessed by those individuals who assist during an emergency and are non-professional assistants.

All other sensitive or secret information, such as information related to medical history, which must be interpreted by a physician, is stored in a separate module. The individuals who access this information would be professional assistants, especially those who are previously registered as such.

In summary, as previously stated, public access of user information is done by scanning the QR code from any mobile phone without using the mobile Android application (downloaded from Google storage), in order for the user to be assisted by an individual who is not necessarily part of the emergency service system. Said public information is limited; that is to say, not all information is publicly available, only a part of it.

In the event the intervening party is part of the system, after entering the specific application, the Administrator will provide more extensive information than the one provided through public access.

Starting from the foregoing definition of the basic structure, the invention considers that the healthcare provider may use the system in other related applications, such as:
Send messages automatically (SMS and e-mails) to those individuals who were designated by the assisted user.
Complete the message information with the cause of the accident, place where the patient will be transported, severity of the assisted user's condition, name and contact information of the Emergency Assistant who is assisting the User.
The system also enables a way to record the treatment already provided and date and time of treatment, in order to be monitored and/or used by the Emergency Assistance service Administration, for different purposes.

In an ideal development, the Web component will be implemented following the Web services scheme, which enables controlled access to the core of the system, and could structure a High Availability methodology if needed (Load Balance, clustering, etc.).

On top of the layer of business regulations, a layer of services (Web services) was built-in in order to provide access to the system and data (both to make amendments and consultations) to the module interphase for mobile devices.

Design of the Computerized Medical History Administrator System Server Installation Initial Database:

A system of servers vitalization was structured with load balance aimed at providing a data service that supports high availability.

In this scheme 3 environments were installed, each with everything needed for an automated system:
a) Development
b) Testing
c) Production

It clearly emerges from the aforementioned that the invented digital and computerized information system adapts to any platform in order to access both mobile phones (“Android”-IOS-“Black Berry”) as well as computers with operating systems “Window” and “Mac”, and “tablets”. In fact it enables not only to hold the individual's emergency information with the photo of the responsible party (allowing for a speedy identification of the subject), but also of his or her family group members, or else the group that is traveling, so that in the event of an accident, by scanning a single QR code it will be possible to obtain the information of all the group or passenger, what we have denominated as a “Temporary Assignment” in the event of a group of travelers, and “Family Assignment” for a group of family members.

On the other hand, it provides the possibility of taking the native language when traveling to foreign countries which allows the user's rescuers to access the information in their own languages; this averts the need to search for an interpreter at the moment of treatment.

There is also everything that is related with contacts which are differentiated by profiles for those who are family members and those who are healthcare providers (attending physician); this is very useful given that when an accident occurs on the road, the system triggers messages to these contacts, which is loaded by the emergency system.

It is also clear that the invented system not only carries the information, transportation, and medical history in an accident, but it also allows the user to consult through the Clinical Guide the information of what his or her condition is at that time, with all the inherent implications: detailed information of what it is, what are the symptoms, how it is diagnosed and treated, how it is prevented, video interviews of world experts speaking about the subject searched.

Using a GPS system is also considered, taken from Google Map, which is a very useful tool for agencies who already have agreed to share information about pathologies and epidemics, among others.

It will be apparent to those skilled in the art and it is contemplated that variations and/or changes in the embodiments illustrated and described herein may be made without departure from the present invention. Accordingly, it is intended that the foregoing description is illustrative only, not limiting, and that the true spirit and scope of the present invention will be determined by the appended claims.

1. A digital and computerized information system to access contact and medical history data of individuals in an emergency situation, which any individual can access through a terminal with Internet access, the system having the purpose of providing the participating user with a special service in the event of an accident, and if the user has to receive emergency assistance, the system providing access to the most important emergency data of the user in order to be taken into consideration by intervening professional assistants, who may inform family members or other contacts of the user regarding the accident, characterized by a combination of resources functionally and mutually linked that may be defined in the following manner:
a QR Code specific to each user who joins the invented system, which constitutes a set parameters link with the identifier (ID), based specifically on user data, and through which it is possible to enter the Central Administration using the mobile phone with Internet access version;
a User (US) is a carrier of a specific QR Code (properly processed and obtained by accessing Central Administration);
a Central Administration, constitutes the system's server and database that stores the users' medical and contact information, and includes:
an Emergency Assistant, conceived to access the server by reading the users QR code, when providing assistance to a user (US) in case of an emergency;

2. A digital and computerized information system to access contact and medical history data of individuals in an emergency situation according to claim 1, characterized by the QR code that is obtained by entering Central Administration through a communication devices (computers, tablets, cell phones, etc.) with Internet access.

3. A digital and computerized information system to access contact and medical history data of individuals in an emergency situation according to claim 1, characterized by the user who joins the system being a user with a monthly or annual membership fee.

4. A digital and computerized information system to access contact and medical history data of individuals in an emergency situation according to claim 1, characterized by the user who joins the system being a user with paid membership.

5. A digital and computerized information system to access contact and medical history data of individuals in an emergency situation according to claim 1, characterized by the Central Administration using a System Administrator enabled to set parameters, control requirements, and create new types of emergency data, and a Users Administrator enabled to create accounts with institutions and individuals who are authorized to provide emergency care services.

6. A digital and computerized information system to access contact and medical history data of individuals in an emergency situation, characterized by the Emergency Assistant the a non-professional assistant who accesses the Server only to take and transmit contact and basic medical data.

7. A digital and computerized information system to access contact and medical history data of individuals in an emergency situation, characterized by the Emergency Assistant being a professional assistant who accesses the Server with the capacity to access important diagnostic medical data in order to guide the emergency treatment.
